(19) United States
(12) Patent Application Publication
(10) Pub. No.: US 2025/0365427 A1
(43) Pub. Date: Nov. 27, 2025

(54) MULTI-RESOLUTION MOTION FEATURE FOR DYNAMIC PCC

(71) Applicant: InterDigital VC Holdings, Inc., Wilmington, DE (US)

(72) Inventors: Junghyun Ahn, New York, NY (US); Jiahao Pang, Plainsboro, NJ (US); Muhammad Asad Lodhi, Highland Park, NJ (US); Dong Tian, Boxborough, MA (US)

(21) Appl. No.: 18/671,759

(22) Filed: May 22, 2024

(51) Int. Cl. H04N 19/137; H04N 19/105; H04N 19/124; H04N 19/13; H04N 19/132; H04N 19/172; H04N 19/42; H04N 19/51

(52) U.S. Cl. CPC H04N 19/137; H04N 19/105; H04N 19/124; H04N 19/13; H04N 19/132; H04N 19/172; H04N 19/42; H04N 19/51

(57) ABSTRACT

Some embodiments of a method may include: obtaining a first motion feature generated by a first set of neural network layers with a current feature and a reference feature as inputs; obtaining a second motion feature generated by a second set of neural network layers with a downsampled current feature and a downsampled reference feature as inputs; generating a third motion feature by a third set of neural network layers by upsampling the second motion feature; generating a multi-resolution motion feature by a fourth set of neural network layers by merging the first and the third motion features; and packing the multi-resolution motion feature into a bitstream.

### INCORPORATION BY REFERENCE

The present application incorporates by reference in their entirety the following applications: U.S. Provisional Patent Application Ser. No. 63/536,321, entitled “ENHANCED FEATURE PROCESSING FOR POINT CLOUD COMPRESSION BASED ON FEATURE DISTRIBUTION LEARNING” and filed Sep. 1, 2023 (“'321 application”); U.S. Provisional Patent Application Ser. No. 63/536,340, entitled “ENHANCED FEATURE PROCESSING FOR IMAGE COMPRESSION BASED ON FEATURE DISTRIBUTION LEARNING” and filed Sep. 1, 2023 (“'340 application”); U.S. Provisional Patent Application Ser. No. 63/543,479, entitled “EXPLICIT PREDICTIVE CODING FOR POINT CLOUD COMPRESSION” and filed Oct. 10, 2023 (“'479 application”); and U.S. Provisional Patent Application Ser. No. 63/543,484, entitled “IMPLICIT PREDICTIVE CODING FOR POINT CLOUD COMPRESSION” and filed Oct. 10, 2023 (“'484 application”).

### BACKGROUND

The field of point cloud compression and processing aims to develop tools for compression, analysis, interpolation, representation and understanding of point cloud signals.

Point cloud is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

### SUMMARY

A first example method in accordance with some embodiments may include: obtaining a first motion feature generated by a first set of neural network layers with a current feature and a reference feature as inputs; obtaining a second motion feature generated by a second set of neural network layers with a downsampled current feature and a downsampled reference feature as inputs; generating a third motion feature by upsampling the second motion feature; generating a multi-resolution motion feature by a third set of neural network layers by merging the first and the third motion features; and packing the multi-resolution motion feature into a bitstream.

Some embodiments of the first example method may further include: obtaining a fourth motion feature generated by a fourth set of neural network layers with inputs of a two or more time downsampled current feature and a two or more time downsampled reference feature; and generating a fifth motion feature by upsampling two or more times the fourth motion feature, wherein generating the multi-resolution motion feature further comprises merging the fifth motion feature with the first and third motion features.

For some embodiments of the first example method, obtaining the first motion feature includes: concatenating the current feature and the reference feature; performing a feature enhancement process on the concatenated current and reference features; and pruning the feature enhanced features to generate the first motion feature.

For some embodiments of the first example method, obtaining the second motion feature includes: downsampling the current and reference features; concatenating the downsampled current feature and the downsampled reference feature; performing a feature enhancement process on the concatenated features; and pruning the feature enhanced features to generate the second motion feature.

For some embodiments of the first example method, generating the third motion feature includes: upsampling the second motion feature; and pruning the upsampled second motion feature to generate the third motion feature.

For some embodiments of the first example method, generating the multi-resolution motion feature includes: concatenating the first and third motion features; and performing a feature enhancement neural network layer process on the concatenated motion features to generate the multi-resolution motion feature.

For some embodiments of the first example method, packing the multi-resolution motion feature into the bitstream includes: quantizing the multi-resolution motion feature; and entropy encoding the quantized multi-resolution motion feature; and arranging the entropy encoded multi-resolution motion feature into the bitstream.

Some embodiments of the first example method may further include generating a main feature by a second set of neural network layers with the current feature and the reference feature as inputs.

For some embodiments of the first example method, generating the main feature includes: downsampling the current feature; downsampling the reference feature; and performing a motion estimation using the downsampled current feature and the downsampled reference feature as inputs.

Some embodiments of the first example method may further include reconstructing a point cloud by a separate set of neural network layers with the bitstream as an input.

A second example method in accordance with some embodiments may include: decoding a multi-resolution motion feature from a bitstream; generating a first motion feature by a first set of neural network layers with the multi-resolution motion feature as an input; generating a second motion feature by a second set of neural network layers with the multi-resolution motion feature as an input; obtaining a reference feature extracted from a reconstructed reference frame; generating a first motion compensated feature by a third set of neural network layers with the first motion feature and the reference feature as inputs; generating a second motion compensated feature by a fourth set of neural network layers with the second motion feature and the reference feature as inputs; and reconstructing a point cloud by a separate set of neural network layers with the first and the second motion compensated features as inputs.

For some embodiments of the second example method, generating the second motion feature includes: performing a neural network layer process on the second motion feature; and downsampling an output of the neural network layer process.

For some embodiments of the second example method, obtaining the reference feature includes: obtaining the reconstructed reference frame; and downsampling the reconstructed reference frame to generate the reference feature.

For some embodiments of the second example method, the first motion compensated feature corresponds to a first level.

For some embodiments of the second example method, the second motion compensated feature corresponds to a second level, and the second level is different from the first level.

For some embodiments of the second example method, reconstructing the point cloud includes: generating a combined motion compensated feature with a first motion feature mix process with the first and the second motion compensated features as inputs; entropy decoding a main feature bitstream; generating a combined downsampled feature with a second motion feature mix process with the concatenated motion compensated feature and the entropy decoded main feature as inputs; and upsampling the combined downsampled feature to generate the reconstructed point cloud.

A third example method in accordance with some embodiments may include: obtaining a reference frame input point cloud; obtaining a current frame input point cloud; downsampling the reference frame; downsampling the current frame; performing a motion estimation with the downsampled reference frame and the downsampled current frame as inputs, wherein performing the motion estimation comprises performing a multi-resolution motion estimation process; quantizing an output of the motion estimation; and entropy encoding the quantized output.

Some embodiments of the third example method may further include arranging the entropy encoded quantized output in a motion feature bitstream.

For some embodiments of the third example method, performing the motion estimation includes: concatenating the downsampled reference frame and the downsampled current frame to generate a concatenated feature; feature enhancing the concatenated feature; and pruning the enhanced feature to generate the output of the motion estimation.

Some embodiments of the third example method may further include generating a main feature by a set of neural network layers with the current feature and the reference feature as inputs.

For some embodiments, an apparatus may be configured to perform any one of the example methods listed above.

### BRIEF DESCRIPTION OF THE DRAWINGS

FIG. 1A is a system diagram illustrating an example communications system according to some embodiments.

FIG. 1B is a system diagram illustrating an example wireless transmit/receive unit (WTRU) that may be used within the communications system illustrated in FIG. 1A according to some embodiments.

FIG. 1C is a system diagram illustrating an example set of interfaces for a system according to some embodiments.

FIG. 1D is a schematic side view illustrating an example waveguide display that may be used with extended reality (XR) applications according to some embodiments.

FIG. 1E is a schematic side view illustrating an example alternative display type that may be used with extended reality applications according to some embodiments.

FIG. 1F is a schematic side view illustrating an example alternative display type that may be used with extended reality applications according to some embodiments.

FIG. 2 is a process diagram illustrating an example learning-based predictive PCC encoder with feature-based motion analysis according to some embodiments.

FIG. 3 is a process diagram illustrating an example feature-based motion estimation according to some embodiments.

FIG. 4 is a process diagram illustrating an example multi-resolution motion features generation process according to some embodiments.

FIG. 5 is a process diagram illustrating an example multi-resolution motion features generation process with shared motion down blocks according to some embodiments.

FIG. 6 is a process diagram illustrating an example multi-resolution motion features alignment and coding process according to some embodiments.

FIG. 7 is a schematic illustration showing an example MIP concatenation for a multi-resolution motion features process according to some embodiments.

FIG. 8 is a process diagram illustrating an example motion enhancement for a multi-resolution motion features process according to some embodiments.

FIG. 9 is a process diagram illustrating an example learning-based predictive PCC decoder with feature-based motion compensation according to some embodiments.

FIG. 10 is a process diagram illustrating an example feature-based multi-resolution motion compensation process according to some embodiments.

FIG. 11 is a process diagram illustrating an example predictor generation process according to some embodiments.

FIG. 12 is a flowchart illustrating an example encoding process according to some embodiments.

FIG. 13 is a flowchart illustrating an example decoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

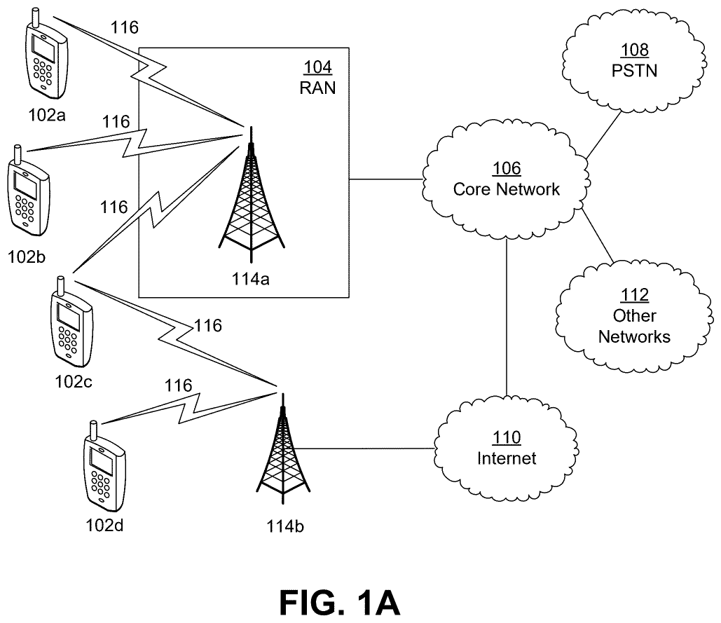

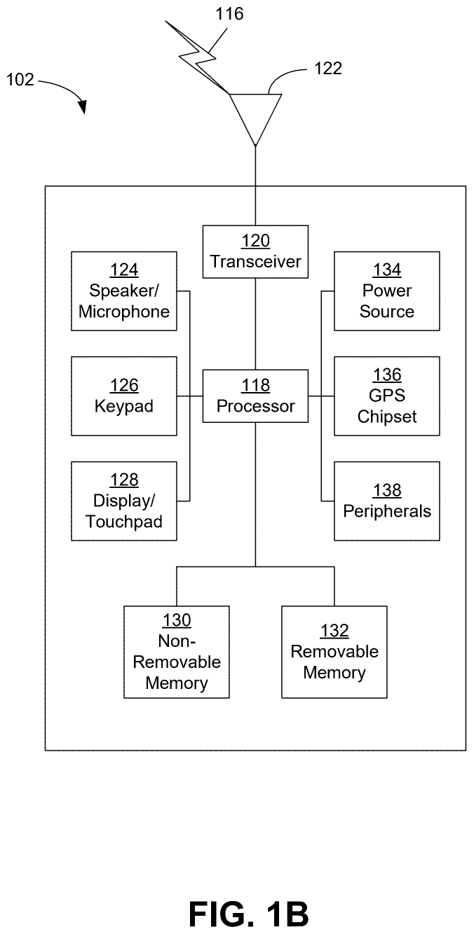

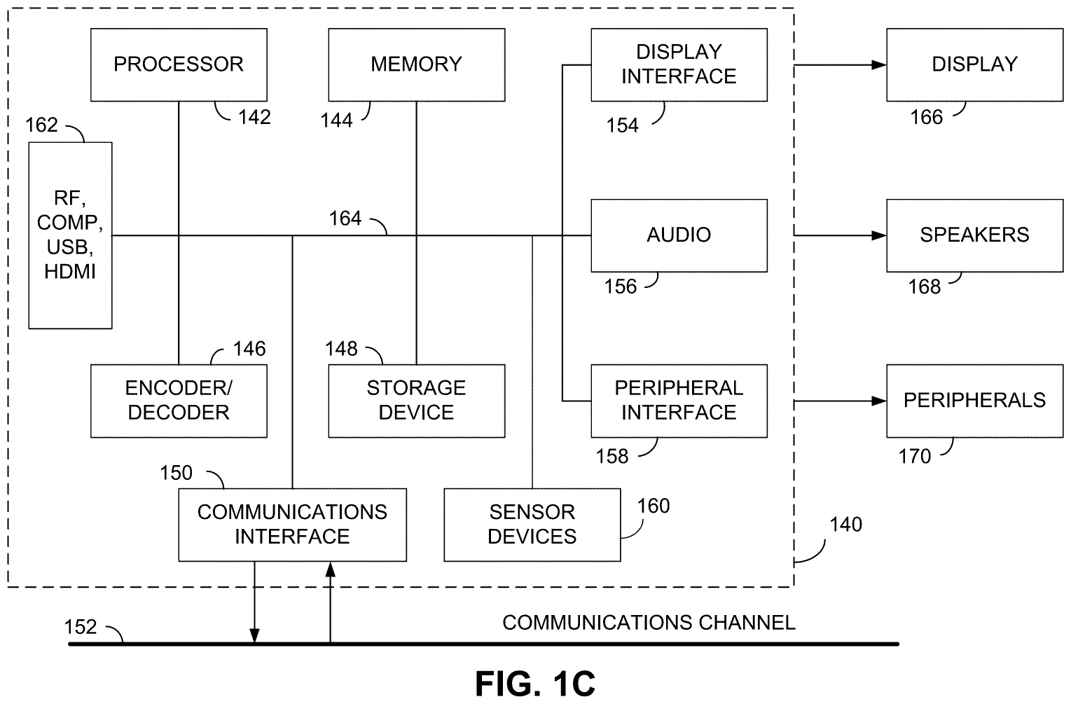

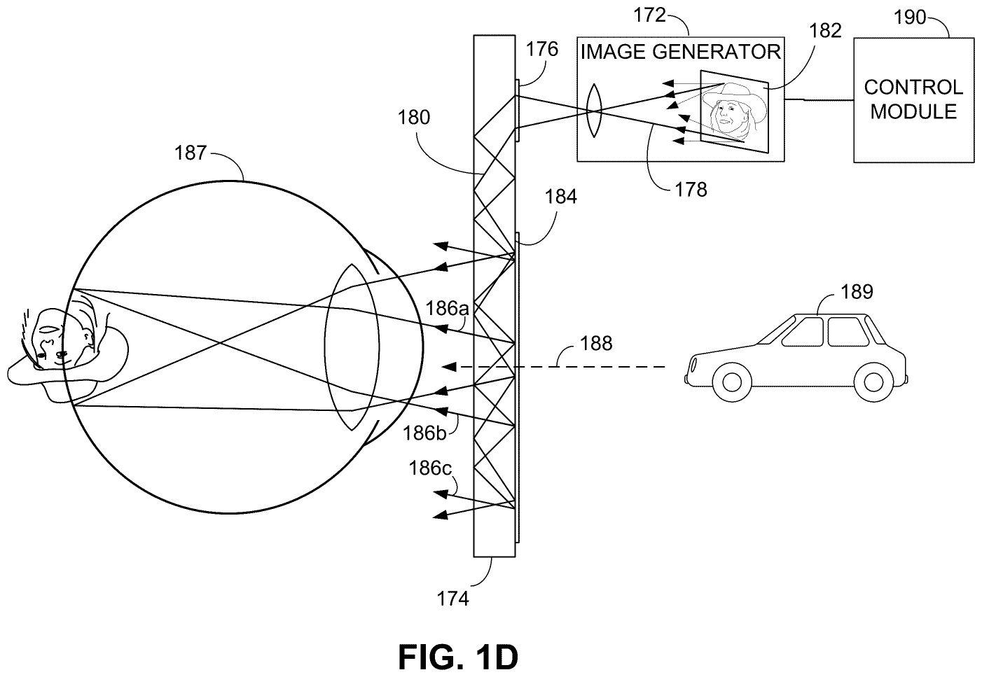

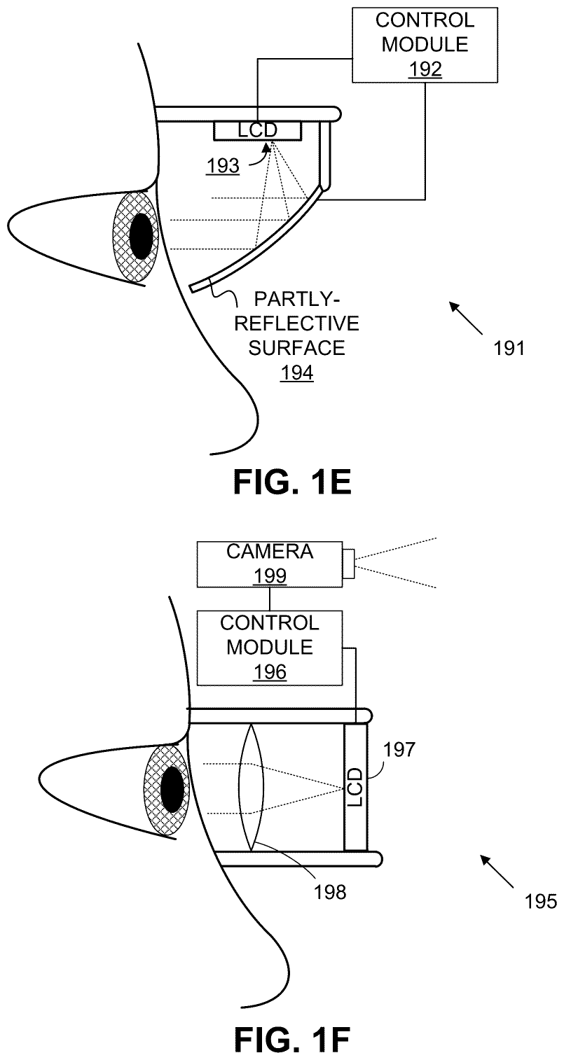

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104/113 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106 may be in direct or indirect communication with other RANs that employ the same RAT as the RAN 104/113 or a different RAT. For example, in addition to being connected to the RAN 104/113, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WT RU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

Although the WTRU is described in FIGS. 1A-1B as a wireless terminal, it is contemplated that in certain representative embodiments that such a terminal may use (e.g., temporarily or permanently) wired communication interfaces with the communication network.

In representative embodiments, the other network 112 may be a WLAN.

In view of FIGS. 1A-1B, and the corresponding description, one or more, or all, of the functions described herein may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1C is a system diagram illustrating an example set of interfaces for a system according to some embodiments. An extended reality display device, together with its control electronics, may be implemented using a system such as the system of FIG. 1C. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (I2C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

FIG. 1D is a schematic side view illustrating an example waveguide display that may be used with extended reality (XR) applications according to some embodiments. An image is projected by an image generator 172. The image generator 172 may use one or more of various techniques for projecting an image. For example, the image generator 172 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 182 generated by the image generator 172 is coupled into a waveguide 174 by a diffractive in-coupler 176. The in-coupler 176 diffracts the light representing the image 182 into one or more diffractive orders. For example, light ray 178, which is one of the light rays representing a portion of the bottom of the image, is diffracted by the in-coupler 176, and one of the diffracted orders 180 (e.g. the second order) is at an angle that is capable of being propagated through the waveguide 174 by total internal reflection. The image generator 172 displays images as directed by a control module 190, which operates to render image data, video data, point cloud data, or other displayable data.

At least a portion of the light 180 that has been coupled into the waveguide 174 by the diffractive in-coupler 176 is coupled out of the waveguide by a diffractive out-coupler 184. At least some of the light coupled out of the waveguide 174 replicates the incident angle of light coupled into the waveguide. For example, in the illustration, out-coupled light rays 186a, 186b, and 186c replicate the angle of the in-coupled light ray 178. Because light exiting the out-coupler replicates the directions of light that entered the in-coupler, the waveguide substantially replicates the original image 182. A user's eye 187 can focus on the replicated image.

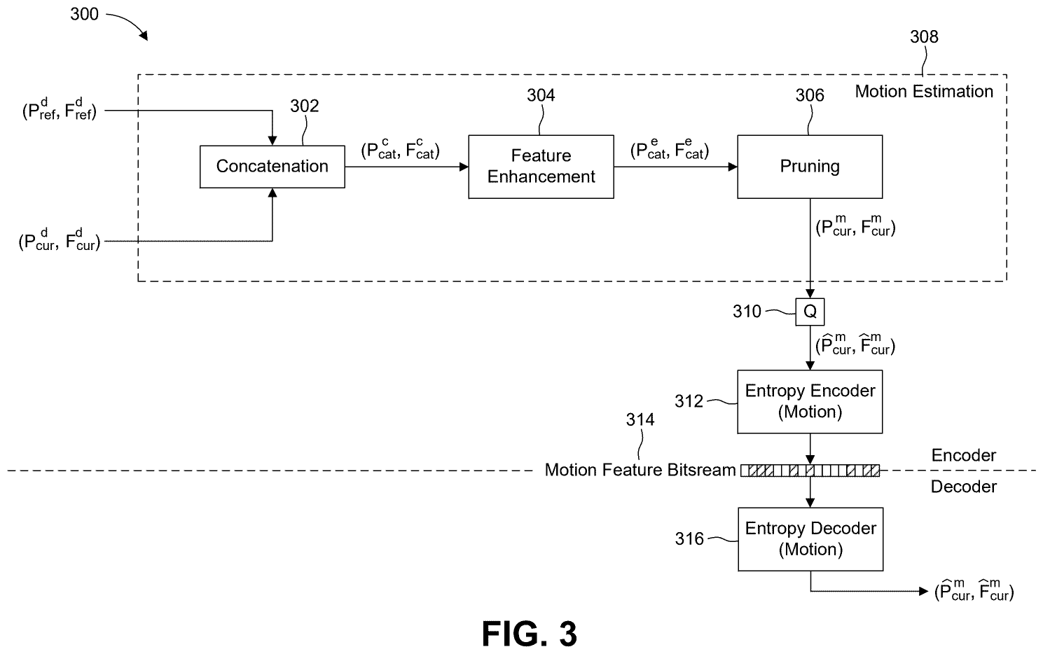

In the example of FIG. 1D, the out-coupler 184 out-couples only a portion of the light with each reflection allowing a single input beam (such as beam 178) to generate multiple parallel output beams (such as beams 186a, 186b, and 186c). In this way, at least some of the light originating from each portion of the image is likely to reach the user's eye even if the eye is not perfectly aligned with the center of the out-coupler. For example, if the eye 187 were to move downward, beam 186c may enter the eye even if beams 186a and 186b do not, so the user can still perceive the bottom of the image 182 despite the shift in position. The out-coupler 184 thus operates in part as an exit pupil expander in the vertical direction. The waveguide may also include one or more additional exit pupil expanders (not shown in FIG. 3A) to expand the exit pupil in the horizontal direction.

In some embodiments, the waveguide 174 is at least partly transparent with respect to light originating outside the waveguide display. For example, at least some of the light 188 from real-world objects (such as object 189) traverses the waveguide 174, allowing the user to see the real-world objects while using the waveguide display. As light 188 from real-world objects also goes through the diffraction grating 184, there will be multiple diffraction orders and hence multiple images. To minimize the visibility of multiple images, it is desirable for the diffraction order zero (no deviation by 184) to have a great diffraction efficiency for light 188 and order zero, while higher diffraction orders are lower in energy. Thus, in addition to expanding and out-coupling the virtual image, the out-coupler 184 is preferably configured to let through the zero order of the real image. In such embodiments, images displayed by the waveguide display may appear to be superimposed on the real world.

FIG. 1E is a schematic side view illustrating an example alternative display type that may be used with extended reality applications according to some embodiments. In an XR head-mounted display device 191, a control module 192 controls a display 193, which may be an LCD, to display an image. The head-mounted display includes a partly-reflective surface 194 that reflects (and in some embodiments, both reflects and focuses) the image displayed on the LCD to make the image visible to the user. The partly-reflective surface 194 also allows the passage of at least some exterior light, permitting the user to see their surroundings.

FIG. 1F is a schematic side view illustrating an example alternative display type that may be used with extended reality applications according to some embodiments. In an XR head-mounted display device 195, a control module 196 controls a display 197, which may be an LCD, to display an image. The image is focused by one or more lenses of display optics 198 to make the image visible to the user. In the example of FIG. 1F, exterior light does not reach the user's eyes directly. However, in some such embodiments, an exterior camera 199 may be used to capture images of the exterior environment and display such images on the display 197 together with any virtual content that may also be displayed.

The embodiments described herein are not limited to any particular type or structure of XR display device.

A User Equipment (UE) may correspond to any eXtended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation and understanding of input signals, such as point clouds.

Point cloud is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when the storage and transmission of the data are used in related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different time. Dynamic point clouds may require the processing and compression to be handled in real-time or with low delay.

### Point Cloud Data Use Cases

The automotive industry and autonomous car are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may help in making a decision.

Virtual Reality (VR) and immersive worlds have become a hot topic and are foreseen by many as the future of 2D flat video. The viewer is immersed in an environment all around the viewer as opposed to standard TV where the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects like statues or buildings are scanned in 3D to share the spatial configuration of the object without sending or visiting the statues or buildings. Also, point clouds offer a way to ensure preservation of the knowledge of the object in case the original object, for instance, is destroyed by an earthquake. Such point clouds are typically static, colored, and huge.

Another use case is in topography and cartography in which using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

### General Challenges

3D point cloud data include discrete samples of the surfaces of objects or scenes. A huge number of points may be used to fully represent the real world with point samples. For instance, a typical VR immersive scene contains millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down sampled) into a bitstream through entropy coding techniques for lossless compression.

In addition to lossless coding, many scenarios for lossy coding seek significantly improved compression ratios while maintaining the induced distortion under certain quality levels. To achieve a less lossy coding, an efficient point cloud feature extractor may be used to improve the accuracy of the reconstruction with a given resource budget.

An additional challenge is efficiently interpreting the sparse nature of the 3D point clouds compared to the regularly arranged 2D pixel samples for the image. To handle this issue, a sparse convolution method may be used, such as the one described in Choy, C. et al., 4D Spatio-Temporal ConvNets: Minkowski Convolutional Neural Networks, IN PROCEEDINGS OF THE IEEE/CVF CONF. ON COMP. VISION AND PATTERN RECOGNITION (CVPR) (2019). Based on a so-called sparse CNN, learning-based point cloud compression (PCC) becomes one of the most interesting topics in the computer vision and machine learning communities.

### Motion Estimation for Point Cloud Compression

In general, a sequence of 3D point cloud does not have temporal correspondence between adjacent time frames. This lack of temporal correspondence makes motion analysis and motion compensation processes more challenging compared to other 3D sequence representations, such as a mesh. For an efficient dynamic point cloud compression (PCC), typically either a motion vector or a motion feature is used as a tool for analyzing and synthesizing motion information. A vector-based approach needs a fine-grained control because each vector points towards a temporally corresponding point or block. On the other hand, feature-based approaches often aggregate features in a down-sampled block level, but careful neural network (NN) layer design is necessary to avoid loss of information during the feature aggregation, motion analysis, or motion compensation steps.

Estimating motion information from reference frame(s) greatly supports the performance of the point cloud compression (PCC) via inter-coding. For a learning-based PCC, different paths exist for retrieving motion information, for example by the motion vector or by the motion feature as a form of a processing tool. The application of the motion feature may be more suitable for a learning-based PCC, in the sense that a motion feature is defined in a higher dimension space implying complex motion information within a feature map. However, some detailed information may be lost in the feature space, making it difficult to recover that detailed information after compression. This application focuses on this problem and seeks to provide an architecture that better encodes a motion feature to overcome this issue.

For feature-based motion estimation, the point clouds of current and reference frames are down-sampled to the bitstream coding level with their corresponding extracted feature maps. They are both concatenated then merged within the motion estimation pipeline to imitate the motion field in a higher dimension space. However, the down-sampled range, which is the receptive field, may not be sufficient to cover all motions between multiple frames. For some embodiments, a learning-based approach generates multi-resolution motion features from multiple down-sampled levels and uses a feature alignment and merging framework to enhance motion feature by combining these multi-resolution features. Based on experimental results, the present application provides a method for improving inter-coding performance of a learning-based dynamic PCC.

Feature-based inter-coding techniques for learning-based dynamic PCC, which may be used with this application, are described in this section.

An implicit feature-based inter-coding technique with residual feature coding is discussed in Akhtar, A., et al., Inter-Frame Compression for Dynamic Point Cloud Geometry Coding, 33 IEEE TRANS. ON IMAGE PROCESSING 584-594 (2024). Unlike motion estimation, only the reference frame is used to predict the current frame. This method aggregates features from the current and reference frames and generates a predictor feature on the down-sampled coordinate of the current frame. A residual feature between the two down-sampled current and predicted features is entropy coded for the reconstruction. Because the motion information is not explicitly packed in a bitstream, a predictor estimates a predicted feature on the decoder side. This implicit method may be efficient for small and simple motions. However, this method may have problems implicitly conveying complex motion(s) during reconstruction.

On the other hand, a feature-based motion estimation method has been proposed in Fan, T., D-DPCC: Deep Dynamic Point Cloud Compression via 3D Motion Prediction, IN PROCEEDINGS OF THE THIRTY-FIRST INTERN'L JOINT CONF. ON ARTIFICIAL INTERLLIGENCE (2022). This approach explicitly generates a motion bitstream with the definition of a motion estimation and motion compensation pair. This approach may be more efficient in learning or inferring more deformable motion because this approach explicitly sends motion information through a motion bitstream. However, this method only considers a single-level motion.

Recently, a patched DPCC was proposed in Pan, Z., et al., patchDPCC: A Patchwise Deep Compression Framework for Dynamic Point Clouds, IN PROCEEDINGS OF THE AAAI CONFERENCE ON ARTIFICIAL INTELLIGENCE (2024) to generate a fixed sized and temporally correlated patch group for each group of frames. This approach also proposes a point-based compression module that leverages inter-frame correlation and point-wise features to improve reconstruction quality. The method may be efficient for slow and less deformable motions but may not be ideal for fast and highly deformable motions, such as ball or cloth movements.

This application seeks to address and overcome these issues and challenges. This application introduces a learning-based motion estimation architecture for efficient dynamic point cloud inter-coding. This application describes a feature-based encoder technique, which enlarges the receptive field of the network during the motion analysis stage and covers a broader range of motions within the output motion feature. An example application may use high performance vision device(s) to capture say a basketball player. Sports movement or a bounding ball are fast motions and may be difficult to compress motion information within a traditionally generated motion feature. Multiple resolution motion feature allows packing of high speed motion during a learning-based PCC encoding process. In an immersive virtual environment (e.g., teleconference or gaming), the PCC decoder unpacks the motion feature with high quality fast motions.

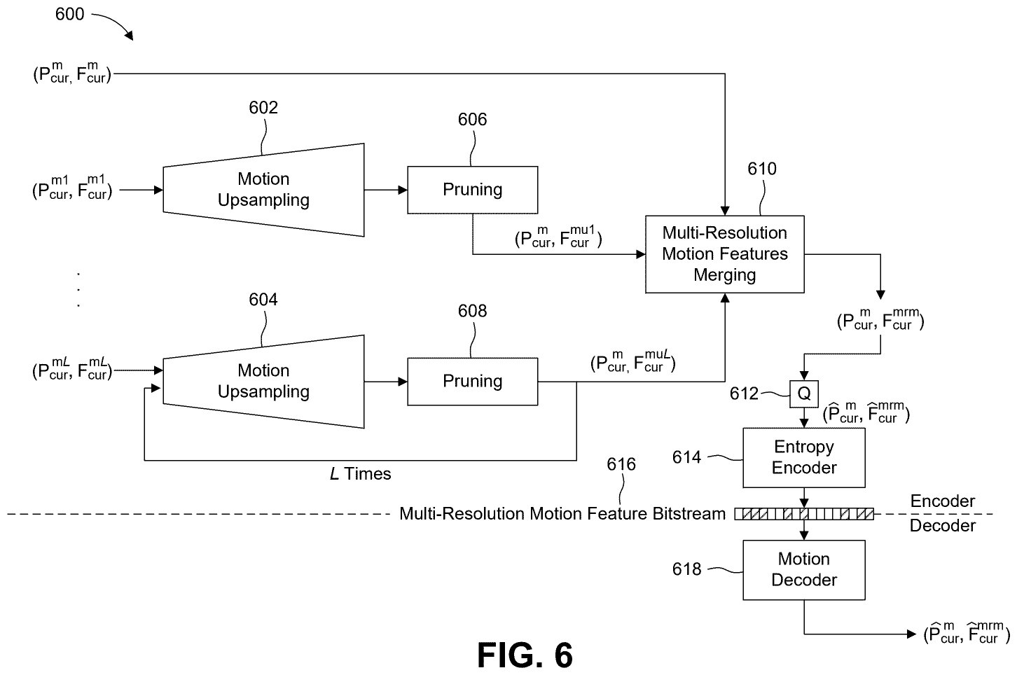

This application discusses an interesting new motion model, which may be used in AI-based Point Cloud Compression (PCC). The motion is based on multi-resolution motion sources. Such a model may be obtained by repeatedly downsampling the current source point cloud and the previous reference point cloud, and computing motion features at each of the downsampled resolution levels. As part of the model, a framework may be used to align and code the multi-resolution motion features (e.g., see FIG. 6). The system is designed to better represent the motion at different scales. An embodiment of the system described herein has been simulated, and the method described herein improves the motion compensation/inter coding performance of an AI-PCC codec.

Dynamic PCC Codec with Feature-Based Motion Analysis

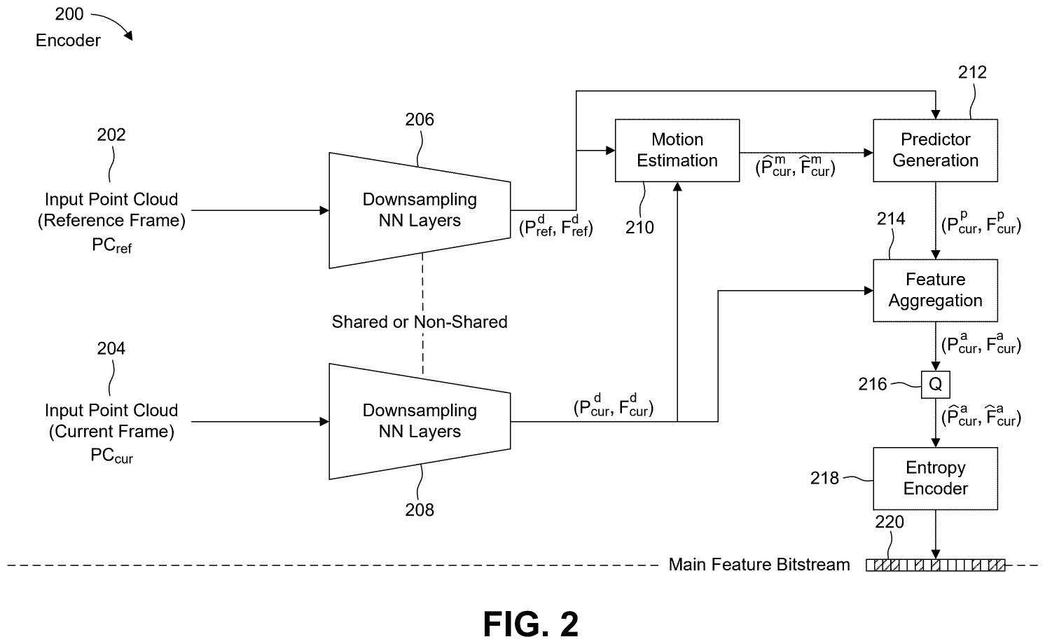

FIG. 2 is a process diagram illustrating an example learning-based predictive PCC encoder with feature-based motion analysis according to some embodiments. This section presents how a multi-resolution motion feature may fit within a learning-based dynamic PCC encoder or similar, as shown in FIG. 2. The corresponding dynamic PCC decoder is described later.

The learning-based encoder architecture for dynamic point cloud compression (PCC) may be characterized by a feature-based motion analysis. The encoder framework 200 takes a current point cloud (PC_{cur}) 202 and a reference point cloud (PC_{ref}) 204 as inputs and extracts feature maps F_{cur}^{d} and F_{ref}^{d}, which may be at a downsampled or lower resolution. The feature extract is performed through a set of downsampling neural network (NN) layers 206, 208. The learned parameters of the down-sampling NN layers may be either shared or non-shared for the current and reference frames feature extraction processes. These compressed features are utilized for the following stages of the encoder.

### Motion Estimation and Motion Feature

The motion estimation block 210 depicted in FIG. 2 takes the above mentioned features as inputs. These features may be described as: 1) a downsampled point cloud's 3D coordinate and feature

$$( {P}_{cur}^{d} , {F}_{cur}^{d} )$$

of the current frame; and 2) a downsampled point cloud's 3D coordinate and feature

$$( {P}_{ref}^{d} , {F}_{ref}^{d} )$$

of the reference frame The motion estimation block 210 outputs a reconstructed motion feature

$${\hat{F}}_{cur}^{m}$$

on the current reconstructed downsampled coordinate

$${\hat{P}}_{cur}^{m} .$$

In some embodiments, the coordinates of

$${\hat{P}}_{cur}^{m} and {P}_{cur}^{d}$$

are identical. The decoded motion feature

$${\hat{F}}_{cur}^{m}$$

is then used to predict the downsampled feature of the current frame.

### Predictor Generation and Predicted Feature

The predictor generation block 212 depicted in FIG. 2, takes the reconstructed motion feature

$${\hat{F}}_{cur}^{m}$$

and the down-sampled reference feature

$${F}_{ref}^{d}$$

as inputs. The predictor generation block 212 outputs a predictor coordinate

$${P}_{cur}^{p}$$

and a feature

$${F}_{cur}^{p} .$$

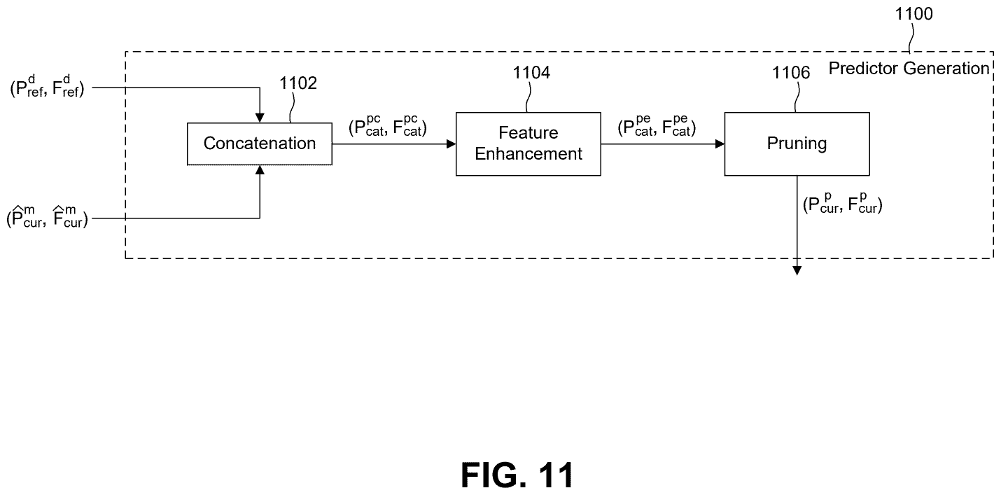

In some embodiments, a predictor generation block may have a similar design as the motion estimation block. See FIG. 11 below for such an example. A feature aggregation block 214 analyzes the original and predicted features

$${F}_{cur}^{d} and {F}_{cur}^{p}$$

and generates the final main feature

$${F}_{cur}^{a} .$$

The aggregated output goes through a quantization block 216 then an entropy encoder 218 before being packed into a main feature bitstream 220.
Dynamic PCC Decoder with Feature-Based Motion Compensation

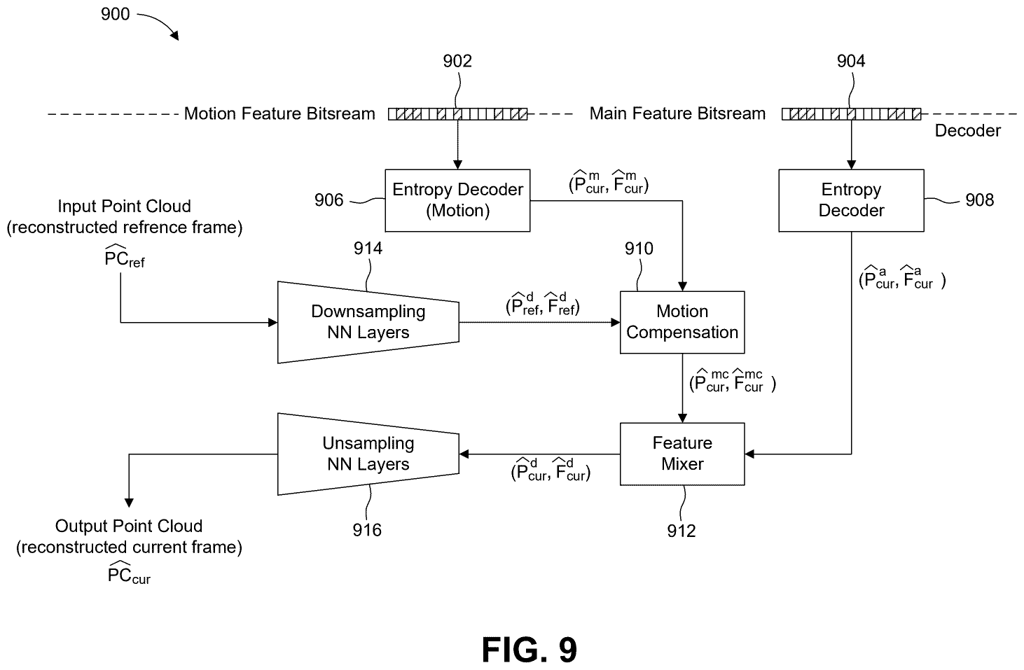

To separate the description of the encoder and the decoder, the decoder is illustrated in FIG. 9. After going through the encoder, for a feature-based motion compensation, a decoder may receive the following inputs: 1) a previously reconstructed point cloud

$${}_{ref} ; 2 )$$

a main feature bitstream; and 3) a motion feature bitstream. These inputs are down-sampled, entropy decoded, and motion entropy decoded to generate: 1) a down-sampled reference feature

$${\hat{F}}_{ref}^{d} ; 2 )$$

an entropy decoded current feature

$${\hat{F}}_{cur}^{a} ; and 3 )$$

an entropy decoded motion feature

$${\hat{F}}_{cur}^{m} ,$$

respectively. The feature-based “Motion Compensation” block takes the features

$${\hat{F}}_{ref}^{d} and {\hat{F}}_{cur}^{m}$$

to generate a motion compensated feature

$${\hat{F}}_{cur}^{mc} ,$$

which will be mixed with

$${\hat{F}}_{cur}^{a}$$

to output

$${\hat{F}}_{cur}^{d} .$$

This feature

$${\hat{F}}_{cur}^{d}$$

that represents the current frame is up-sampled through the “Up-sampling NN Layers”, then output the final reconstructed point cloud

$${}_{cur} .$$

The motion bitstream is generated in the encoder, inside the motion estimation block 210 in FIG. 2. During the encoding process, decoding of the motion bitstream may be required. A detailed example to encode a motion bitstream is shown in FIG. 3.

### Feature-Based Motion Estimation

FIG. 3 is a process diagram illustrating an example feature-based motion estimation according to some embodiments. A feature-based motion estimation process 300 is illustrated in FIG. 3.

### Features Concatenation

Information from both frames are combined by a concatenation block 302 to concatenate the current features

$${F}_{cur}^{d}$$

and the reference features

$${F}_{ref}^{d} .$$

Since both features do not share the same point coordinates (in other words,

$${P}_{cur}^{d} and {P}_{ref}^{d}$$

are not identical), the concatenation block 302 considers the union of current and reference points. For the current and reference frame intersecting points, both

$${F}_{cur}^{d} and {F}_{ref}^{ d}$$

are concatenated. If a point corresponds only to the current frame, then

$${F}_{cur}^{d}$$

is concatenated with a zero-feature that has the same channel dimension as

$${F}_{ref}^{d} .$$

If a point corresponds only to the reference frame, then

$${F}_{ref}^{d}$$

is concatenated with a zero-feature that has the same channel dimension as the

$${F}_{cur}^{d} .$$

### Feature Enhancement

The concatenated features

$${F}_{cat}^{c}$$

go through a series of feature enhancement NN layers in the feature enhancement block 304 to output an enhanced feature

$${F}_{cat}^{e} .$$

For some embodiments, a series of CNN or MLP layers are added within the feature enhancement block 304. For some embodiments, a multi-stage IRN (such as the one described in Szegedy, C., et al., Inception-v4, Inception-ResNet and the Impact of Residual Connections on Learning, 31:1 IN PROCEEDINGS OF THE AAAI CONFERENCE ON ARTIFICIAL INTELLIGENCE (2017)), a transformer (such as the one described in Mao, J., et al., Voxel Transformer for 3D Object Detection, IN PROCEEDINGS OF THE IEEE/CVF INTERNATIONAL CONFERENCE ON COMPUTER VISION (ICCV) (2021)), a DDA-Net block (which is described in Ahn, J., et al., DDA-Net: Deep Distribution-Aware Network for Point Cloud Compression, IN 2023 IEEE INTERNATIONAL SYMPOSIUM ON CIRCUITS AND SYSTEMS (ISCAS) (2023)), or other feature enhancement network may be combined with CNN or MLP layers. For some embodiments, the '745 and '765 applications illustrate some example applications of DDA-Net, such as feature enhancement blocks within frameworks for point cloud compression and image/video compression.

### Motion Feature Reconstruction

A pruning process 306 is used to keep only the necessary features F_{cur}^{m} before going through a quantizer 310 and an entropy encoder 312 to generate the motion feature bitstream 314. The motion feature bitstream 314 goes through a motion decoder block 316 to reconstruct the decoded motion feature

$${\hat{F}}_{cur}^{m} .$$

The decoding process 316 is emulated within the encoder for the purpose of feeding the estimated motion feature to the predictor generation block. More detail on the motion entropy decoding is depicted in FIG. 9. For some embodiments, a motion estimation process 308 may include a concatenation block 302, a feature enhancement block 304, and a pruning block 306.

### Multi-Resolution Motion Estimation

The motion estimation process (e.g., block 210 of FIG. 2) described in the previous sub-section, considers inter-coding between single level downsampled features. This resolution motion analysis may be limited in understanding different motion styles, such as small, medium, or large motions. A multi-resolution motion analysis is beneficial to cover various motion types. For some embodiments, the motion estimation block 308 in FIG. 3 may serve as a unit block for processing motion features at each level. The generation of multi-resolution motion feature(s) and the corresponding encoding out to a bitstream/decoding from a bitstream are thought to be novel.

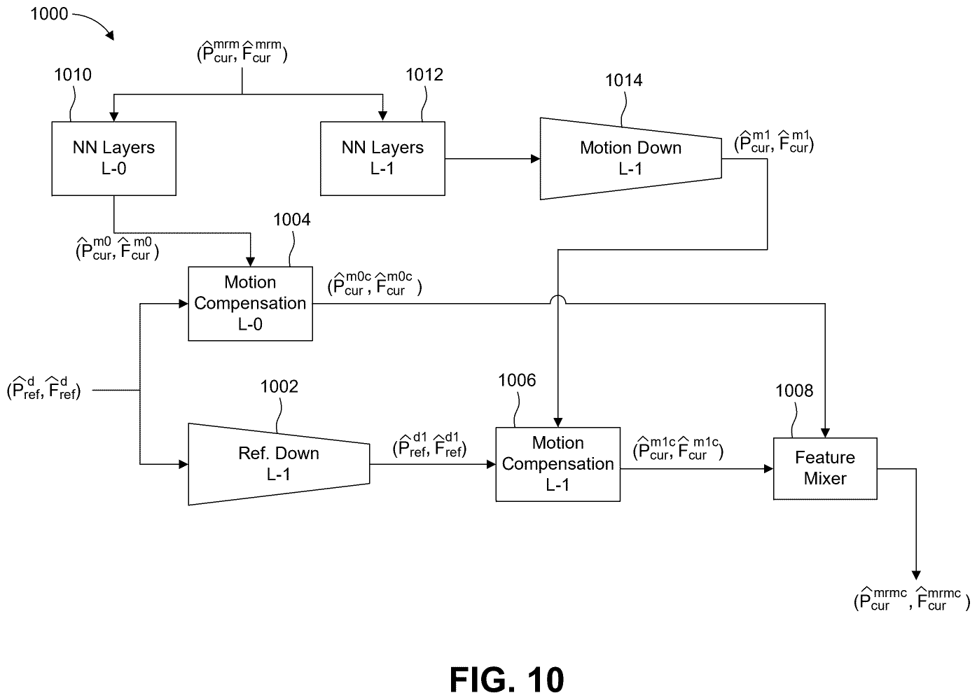

For some embodiments, an expandable architecture may be used to generate L-level motion features. This design makes a learning-based predictive PCC framework more applicable to general point cloud compression (PCC) cases. Some embodiments may work efficiently for both dense (immersive) and sparse (autonomous driving) PCC. By increasing the number of multiple resolutions, very fast motion may be embedded in or learned for a motion feature. An example multi-resolution motion compensation block is provided in FIGS. 9 and 10.

### Multi-Resolution Motion Features Generation

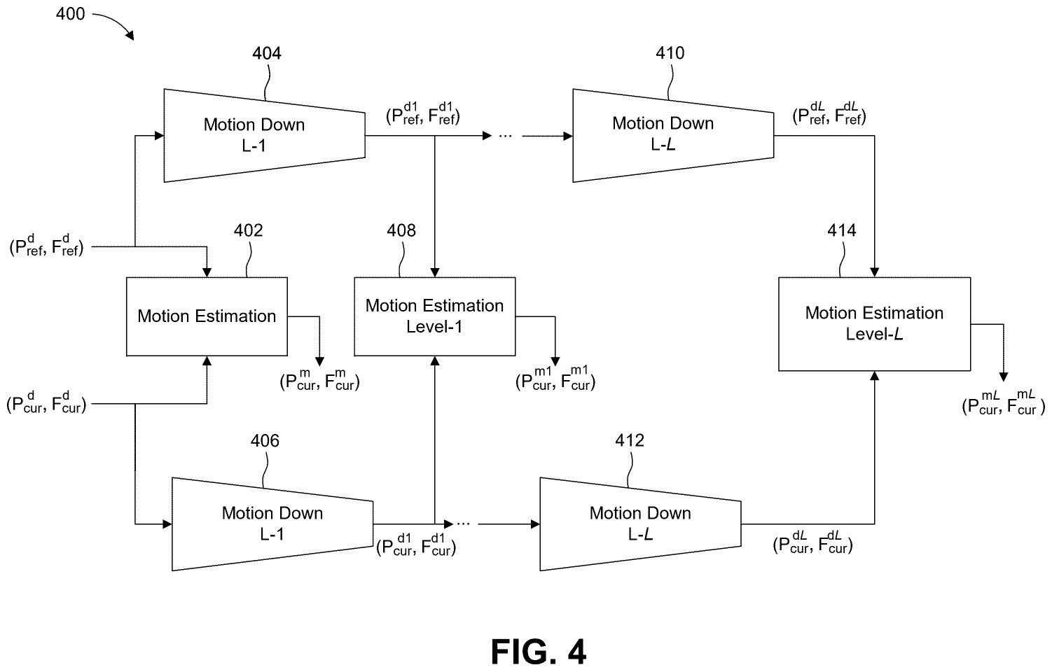

FIG. 4 is a process diagram illustrating an example multi-resolution motion features generation process according to some embodiments. As illustrated in FIG. 4, a multi-resolution motion estimation process 400 is designed to generate a series of motion features from levels 1 to L, in addition to the level-0 motion features F_{cur}^{m} generated by the motion estimation block 402. The current features F_{cur}^{d} and reference features F_{ref}^{d} are downsampled through the “Motion Down L-1” blocks 404 406. The L-1 outputs are downsampled 3D coordinates and features for the current point cloud

$$( {P}_{cur}^{d 1} , {F}_{cur}^{d 1} )$$

and downsampled 3D coordinates and features for the reference point cloud

$$( {P}_{ref}^{d 1} , {F}_{ref}^{d 1} ) .$$

These level-1 motion features go through the “Motion Estimation Level-1” block 408, which outputs a level-1 motion feature F_{cur}^{m1}. The “Motion Estimation Level-1” block 408 is identical to the dash-lined “Motion Estimation” block 308 illustrated in FIG. 3. Based on the target motion style, extension up to level-L motion feature

$${F}_{cur}^{mL}$$

may be possible by combining the “Motion Down L-L” blocks 410, 412 and the “Motion Estimation Level-L” block 414. For each additional level, the block size of each point cloud frame increases by a factor of 2. This means a down-sampling process gathers 8 voxels (cube shaped) into 1 voxel. The size (length) of this down-sampled voxel is two-times bigger than a voxel before down-sampling. For each additional level, a down-sampling process occurs. So each time, the block size increases by 2. This increase eventually enlarges the range of motion covered by multi-resolution motion features

$${F}_{cur}^{m 1} , {F}_{cur}^{m 2} , … , and {F}_{cur}^{mL} .$$

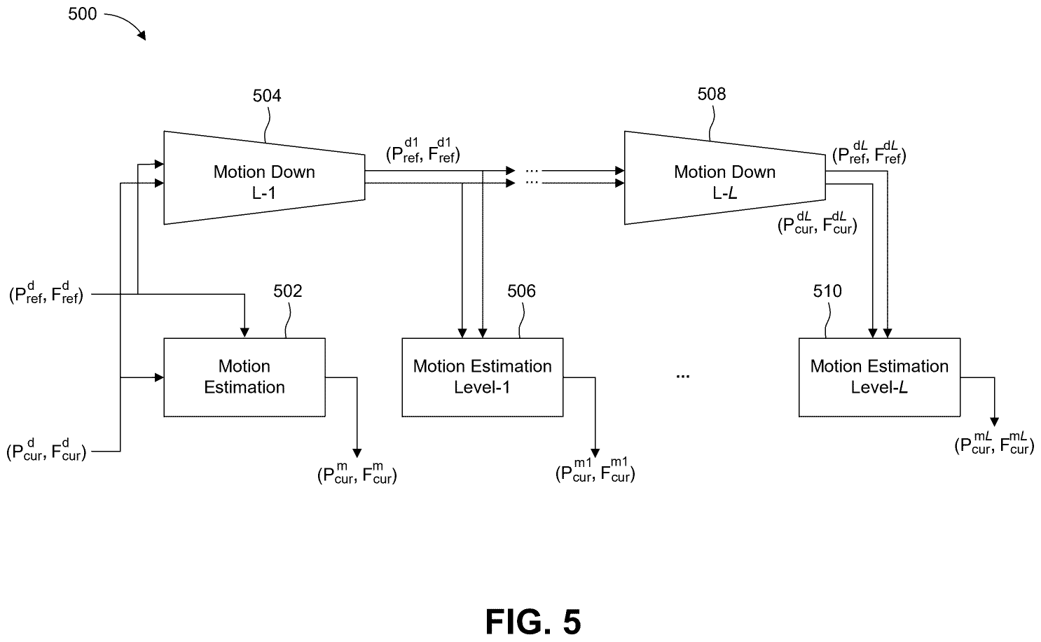

FIG. 5 is a process diagram illustrating an example multi-resolution motion features generation process with shared motion down blocks according to some embodiments. For some embodiments, as depicted in FIG. 5, the “Motion Down” blocks 504, 508 of each level may be shared for the current and reference features downsampling processes. The multi-resolution motion estimation process 500 uses a motion estimation block 502 to generate the level-0 motion coordinates

$${P}_{cur}^{m}$$

and motion features

$${F}_{cur}^{m} .$$

A series of motion coordinates and features from levels 1 to L are generated by a series of motion estimation blocks 506, 510 for levels 1 to L.

### Multi-Resolution Motion Features Alignment

FIG. 6 is a process diagram illustrating an example multi-resolution motion features alignment and coding process according to some embodiments. To combine

$${F}_{cur}^{m 1} , {F}_{cur}^{m 2} , … , and {F}_{cur}^{mL} to {F}_{cur}^{m} ,$$

each additional level of motion is matched to the resolution of 3D coordinates

$${P}_{cur}^{m} .$$

As illustrated in FIG. 6, a 1-time motion upsampling process that includes a motion upsampling block 602 and a pruning block 606 is performed for level-1 motion feature and an L-time upsampling process that includes a motion upsampling block 604 and a pruning block 608 is performed for level-L. Each motion upsampling block is followed by a pruning block for discarding unnecessary point coordinates. After the up-sampling stage, the motion feature of each level is arranged as follows:

$$( {P}_{cur}^{m} , {F}_{cur}^{m} ) , ( {P}_{cur}^{m} , {F}_{cur}^{mu 1} ) , … , and ( {P}_{cur}^{m} , {F}_{cur}^{muL} ) .$$

The “u” in the superscript stands for “upsampled.” The motion feature(s) mu1 may or may not be identical to m1, depending on the design of motion upsampling block. The “multi-resolution motion features merging” block 610 take these aligned features to output the multi-resolution motion feature

$${F}_{cur}^{mrm} .$$

Like the single-resolution case, the multi-resolution motion feature may go through a quantization block 612 and an entropy encoder 614 to generate a multi-resolution motion feature bitstream 616. The multi-resolution motion feature bitstream 616 may go through a motion decoder 618 to reconstruct the decoded feature

$${\hat{F}}_{cur}^{mrm} .$$

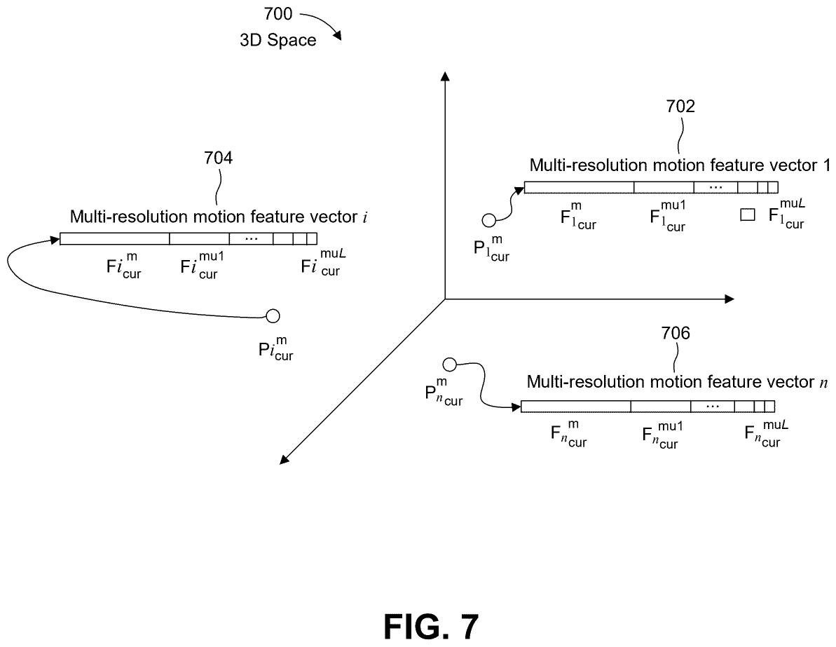

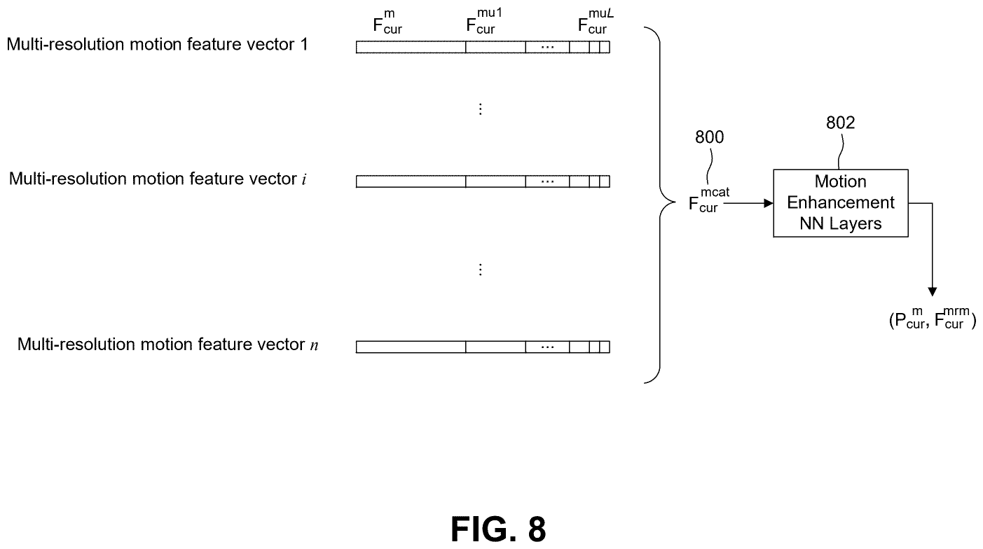

The “mr” in the superscript stands for multi-resolution. The “multi-resolution motion features merging” block 610 is further illustrated as a two-step process in FIG. 7 and FIG. 8. For some embodiments, there may be a decoder block within the encoder to mimic the decoding process. For some embodiments, each level of the level 2 (or L-2 for some embodiments) to level L (or L-L for some embodiments) has a feedback loop that is performed a respective 2, 3, . . . or L number of times.

An example method in accordance with some embodiments may include: obtaining a first motion feature generated by a first set of neural network layers with a current feature and a reference feature as inputs; obtaining a second motion feature generated by a second set of neural network layers with a downsampled current feature and a downsampled reference feature as inputs; generating a multi-resolution motion feature by a third set of neural network layers by merging the first and second motion features; and packing the multi-resolution motion feature into a bitstream. Some embodiments of the example method may further include one or more steps of obtaining a third and/or higher level motion feature and merging the third and/or higher level motion feature with the other motion features. For some embodiments, an apparatus may be configured to perform the example method.

### Multi-Resolution Motion Features Merging

FIG. 7 is a schematic illustration showing an example MIP concatenation for a multi-resolution motion features process according to some embodiments. In the first step, a multi-resolution motion feature vector 702, 704, 706 for each level is concatenated in a “multum in parvo” (MIP) manner. In other words, a smaller size of feature channel dimension is assigned to a higher-level motion feature. As depicted in the vectors shown in the 3D space 700 of FIG. 7, the channel allocation size reduces by 2 for each additional level. Because the point cloud frame downsamples for each additional level, the channel decreases in proportion to the number of points. In some embodiments, the channel allocation size may be uniform for each additional level, which is expected to bring more weights if analyzing larger motions.

FIG. 8 is a process diagram illustrating an example motion enhancement for a multi-resolution motion features process according to some embodiments. The concatenated motion feature

$${F}_{cur}^{mcat}$$

800 is inputted into the “motion enhancement NN layers” block 802 to generate the final enhanced multi-resolution motion feature

$${F}_{cur}^{mrm} .$$

### Multi-Resolution Motion Compensation

FIG. 9 is a process diagram illustrating an example learning-based predictive PCC decoder with feature-based motion compensation according to some embodiments. A main feature bitstream 904 is passed through an entropy decoder 908 to generate reconstructed current main coordinates

$${\hat{P}}_{cur}^{a}$$

and reconstructed current main features

$${\hat{F}}_{cur}^{a} .$$

A motion feature bitstream 902 is passed through a motion entropy decoder 906 to generate reconstructed current motion coordinates

$${\hat{P}}_{cur}^{m}$$

and reconstructed current motion features

$${\hat{F}}_{cur}^{m} .$$

The decoder framework 900 takes a reconstructed reference point cloud

$$( {ref}_{} )$$

as an input to a downsampling NN layers block 914 and extracts reconstructed reference coordinates

$${\hat{P}}_{ref}^{d}$$

and a reconstructed reference feature map

$${\hat{F}}_{ref}^{d} ,$$

which may be at a downsampled or lower resolution. For some embodiments, the main feature bitstream 904 and the motion feature bitstream 902 are part of the same bitstream. They may be encoded and decoded based on high level syntax (HLS). In FIG. 9, the main feature bitstream 904 and the motion feature bitstream 902 are split to enable a more readable description of FIG. 9.

The motion compensation block 910 takes as inputs the reconstructed current motion 3D coordinates

$${\hat{P}}_{cur}^{m} ,$$

the reconstructed current motion feature map \hat{F}_{cur}^{m}, the reconstructed 3D coordinates

$${\hat{P}}_{cur}^{d} ,$$

the reconstructed feature map

$${\hat{F}}_{cur}^{d} .$$

The motion compensation block 910 outputs a reconstructed current motion compensation feature

$${\hat{F}}_{cur}^{mc}$$

on the reconstructed current downsampled motion compensation coordinate

$${\hat{P}}_{cur}^{mc} .$$

The reconstructed current motion compensated 3D coordinates

$${\hat{P}}_{cur}^{mc}$$

and reconstructed current motion compensated feature map

$${\hat{F}}_{cur}^{mc}$$

are merged with the reconstructed main 3D coordinates

$${\hat{P}}_{cur}^{a}$$

and reconstructed main feature map

$${\hat{F}}_{cur}^{a}$$

by the “feature mixer” block 912 to generate reconstructed current 3D coordinates

$${\hat{P}}_{cur}^{d}$$

and a reconstructed current feature map

$${\hat{F}}_{cur}^{d} .$$

The reconstructed current 3D coordinates

$${\hat{P}}_{cur}^{d}$$

current feature map

$${\hat{F}}_{cur}^{d}$$

go through an upsampling NN layers block 916 to generate a reconstructed current point cloud

$$( {cur}_{} ) .$$

For decoding a multi-resolution motion feature, the

$${\hat{F}}_{cur}^{m}$$

in FIG. 9 may be interpreted as, or replaced by, the decoded feature

$${\hat{F}}_{cur}^{mrm} .$$

A PCC framework is trained in an end-to-end manner. For some embodiments, a first (current) level motion feature may be generated by a first set of neural network layers with the multi-resolution motion feature as an input. A second set of neural network layers also takes the above multi-resolution motion feature as an input and generates a second motion feature. Then, the second motion feature goes through a set of down-sampling neural network (NN) layers to generate a down-sampled second-level motion feature. Since the PCC framework is trained end-to-end, distinguishing the functionality between the first and second sets of neural network layers is possible.

For some embodiments, a first (current) level motion compensated feature may be generated by a third set of neural network layers with the first motion feature and the reference feature as inputs. A second level motion compensated feature may be generated by a fourth set of neural network layers with the second motion feature and the reference feature as inputs. For the second level, the reference feature may be downsampled before sending to the fourth set of neural network layers. This multi-level motion compensation mechanism may be expanded to an L-level motion feature. For some embodiments, the number of motion levels may be matched to the number of motion levels generated on the encoder.

FIG. 10 is a process diagram illustrating an example feature-based multi-resolution motion compensation process according to some embodiments. Some embodiments of the “motion compensation” block 910 of FIG. 9 may take the multi-resolution motion feature as one of the inputs as shown in the process 1000 of FIG. 10. From a combined multi-resolution motion feature

$${\hat{F}}_{cur}^{mrm} ,$$

two NN layers L-0 (1010) and L-1 (1012) learn how to split different level of motion features. The NN layers L-1 block 1012 is followed by a downsampling layers block 1014 that outputs a lower resolution motion feature

$${\hat{F}}_{cur}^{m 1} .$$

The reference 3D coordinates

$${\hat{P}}_{ref}^{d}$$

and reference feature

$${\hat{F}}_{ref}^{d}$$

go through a reference downsampling L-1 layer block 1002 to generate

$${\hat{P}}_{ref}^{d 1} and {\hat{F}}_{ref}^{d 1} .$$

Each decoded motion feature

$${\hat{F}}_{cur}^{m 0} and {\hat{F}}_{cur}^{m 1 }$$

is paired with a corresponding reference feature

$${\hat{F}}_{ref}^{d 1} and {\hat{F}}_{ref}^{d 1} ,$$

respectively. Each pair passes through a “motion compensation L-0” block 1004 and a “motion compensation L-1” block 1006 to output a motion compensated feature for each level,

$${\hat{F}}_{cur}^{m 0 c} and {\hat{F}}_{cur}^{m 1 c} .$$

These level-0 and level-1 motion compensated features are then merged with the “feature mixer” block 1008.

During the mixing stage, the level-1 feature

$${\hat{F}}_{cur}^{m 1 c}$$

may use an upsampling layers block and a pruning block to align coordinates with the level-0 feature

$${\hat{F}}_{cur}^{m 0 c} .$$

Once aligned, the mixing of features may be done with a concatenation followed by feature enhancement layers. In some embodiments, the final multi-resolution motion compensated feature

$${\hat{F}}_{cur}^{mrmc}$$

may be the motion compensated feature

$${\hat{F}}_{cur}^{mc}$$

described in FIG. 9. For some embodiments, additional levels for level 2 (or L-2 for some embodiments) to level L (or L-L for some embodiments) may be used. Such levels may operate similar to the level L-1 shown with reference downsampling 1002 and motion downsampling 1014 being performed 2 or more times according to the respective level and a corresponding upsampling process (not shown) also being performed.

FIG. 11 is a process diagram illustrating an example predictor generation process according to some embodiments. A feature-based predictor generation process 1100 is illustrated in FIG. 11. In some embodiments, a predictor generation block may have a similar design to a motion estimation block. As illustrated in FIG. 11, a down-sampled reference feature,

$${F}_{ref}^{d} , and {\hat{F}}_{cur}^{m}$$

may be concatenated via a concatenation process 1102. The concatenated features may go through a feature enhancement process 1104 to output a predicted feature

$${F}_{cat}^{pe}$$

on concatenated point coordinates

$${P}_{cat}^{p e} .$$

A pruned feature,

$${F}_{cur}^{p} ,$$

is then outputted by a pruning process 1106.

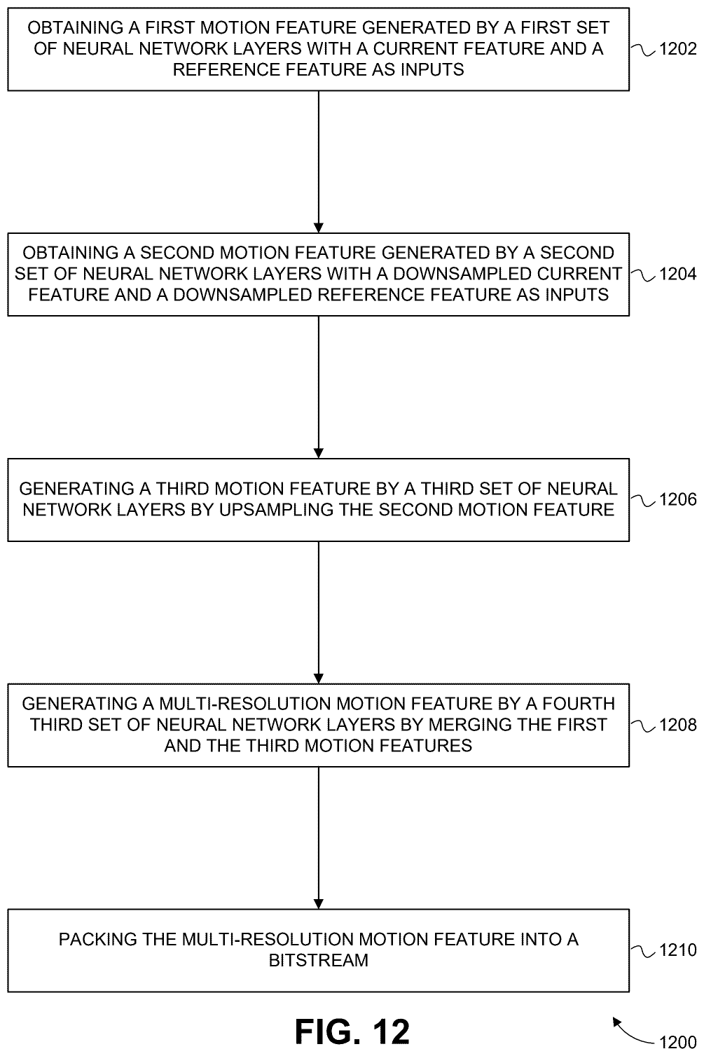

FIG. 12 is a flowchart illustrating an example encoding process according to some embodiments. For some embodiments, an example process 1200 may include obtaining 1202 a first motion feature generated by a first set of neural network layers with a current feature and a reference feature as inputs. For some embodiments, the example process 1200 may further include obtaining 1204 a second motion feature generated by a second set of neural network layers with a downsampled current feature and a downsampled reference feature as inputs. For some embodiments, the example process 1200 may further include generating 1206 a third motion feature by upsampling the second motion feature. For some embodiments, the example process 1200 may further include generating 1208 a multi-resolution motion feature by a third set of neural network layers by merging the first and the third motion features. For some embodiments, the example process 1200 may further include packing 1210 the multi-resolution motion feature into a bitstream. For some embodiments, the encoding process 1100 of FIG. 11 may be performed in an apparatus.

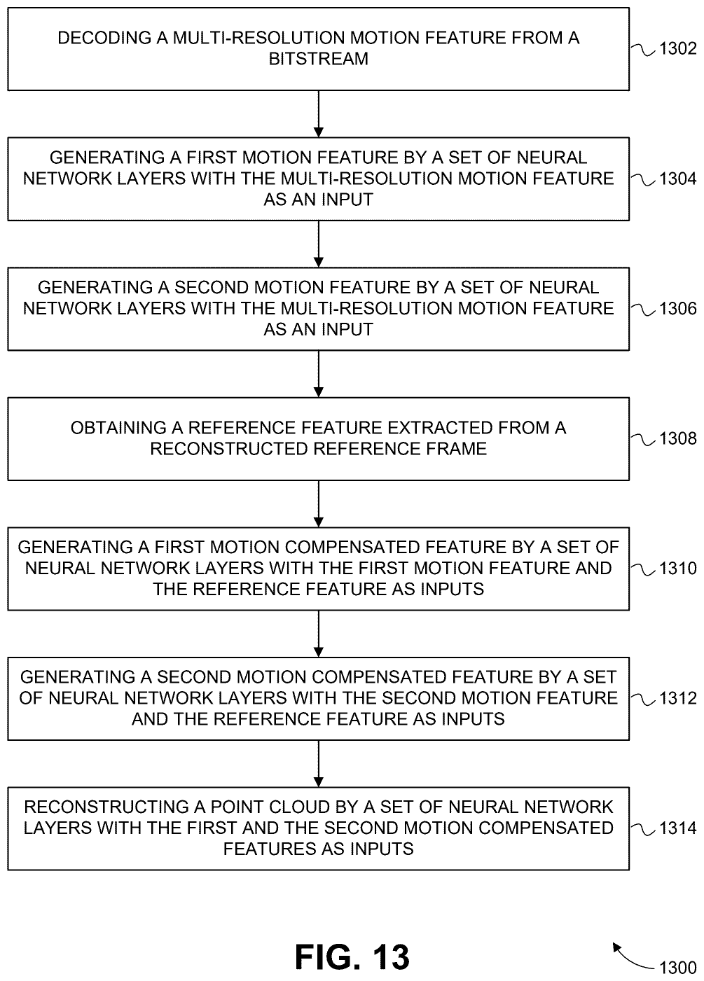

FIG. 13 is a flowchart illustrating an example decoding process according to some embodiments. For some embodiments, an example process 1300 may include decoding 1302 a multi-resolution motion feature from a bitstream. For some embodiments, the example process 1300 may further include generating 1304 a first motion feature by a set of neural network layers with the multi-resolution motion feature as an input. For some embodiments, the example process 1300 may further include generating 1306 a second motion feature by a set of neural network layers with the multi-resolution motion feature as an input. For some embodiments, the example process 1300 may further include obtaining 1308 a reference feature extracted from a reconstructed reference frame. For some embodiments, the example process 1300 may further include generating 1310 a first motion compensated feature by a set of neural network layers with the first motion feature and the reference feature as inputs. For some embodiments, the example process 1300 may further include generating 1312 a second motion compensated feature by a set of neural network layers with the second motion feature and the reference feature as inputs. For some embodiments, the encoding process 1200 of FIG. 12 may be performed in an apparatus.

For some embodiments, the example process 1200 may further include reconstructing 1214 a point cloud by a set of neural network layers with the first and the second motion compensated features as inputs.

An example method in accordance with some embodiments may include: generating a motion feature by a set of neural network layers with a motion feature bitstream as an input; obtaining a reference feature extracted from a reconstructed reference frame; generating a motion compensated feature by a set of neural network layers with the first motion feature and the reference feature as inputs; and reconstructing a point cloud by a separate set of neural network layers with the motion compensated feature as an input.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining a first motion feature generated by a first set of neural network layers with a current feature and a reference feature as inputs; obtaining a second motion feature generated by a second set of neural network layers with a downsampled current feature and a downsampled reference feature as inputs; generating a third motion feature by upsampling the second motion feature; generating a multi-resolution motion feature by a third set of neural network layers by merging the first and the third motion features; and packing the multi-resolution motion feature into a bitstream.

Some embodiments of the first example method may further include: obtaining a fourth motion feature generated by a fourth set of neural network layers with inputs of a two or more time downsampled current feature and a two or more time downsampled reference feature; and generating a fifth motion feature by upsampling two or more times the fourth motion feature, wherein generating the multi-resolution motion feature further comprises merging the fifth motion feature with the first and third motion features.

For some embodiments of the first example method, obtaining the first motion feature includes: concatenating the current feature and the reference feature; performing a feature enhancement process on the concatenated current and reference features; and pruning the feature enhanced features to generate the first motion feature.

For some embodiments of the first example method, obtaining the second motion feature includes: downsampling the current and reference features; concatenating the downsampled current feature and the downsampled reference feature; performing a feature enhancement process on the concatenated features; and pruning the feature enhanced features to generate the second motion feature.

For some embodiments of the first example method, generating the third motion feature includes: upsampling the second motion feature; and pruning the upsampled second motion feature to generate the third motion feature.

For some embodiments of the first example method, generating the multi-resolution motion feature includes: concatenating the first and third motion features; and performing a feature enhancement neural network layer process on the concatenated motion features to generate the multi-resolution motion feature.

For some embodiments of the first example method, packing the multi-resolution motion feature into the bitstream includes: quantizing the multi-resolution motion feature; and entropy encoding the quantized multi-resolution motion feature; and arranging the entropy encoded multi-resolution motion feature into the bitstream.

Some embodiments of the first example method may further include generating a main feature by a second set of neural network layers with the current feature and the reference feature as inputs.

For some embodiments of the first example method, generating the main feature includes: downsampling the current feature; downsampling the reference feature; and performing a motion estimation using the downsampled current feature and the downsampled reference feature as inputs.

Some embodiments of the first example method may further include reconstructing a point cloud by a separate set of neural network layers with the bitstream as an input.

A second example method in accordance with some embodiments may include: decoding a multi-resolution motion feature from a bitstream; generating a first motion feature by a first set of neural network layers with the multi-resolution motion feature as an input; generating a second motion feature by a second set of neural network layers with the multi-resolution motion feature as an input; obtaining a reference feature extracted from a reconstructed reference frame; generating a first motion compensated feature by a third set of neural network layers with the first motion feature and the reference feature as inputs; generating a second motion compensated feature by a fourth set of neural network layers with the second motion feature and the reference feature as inputs; and reconstructing a point cloud by a separate set of neural network layers with the first and the second motion compensated features as inputs.

For some embodiments of the second example method, generating the second motion feature includes: performing a neural network layer process on the second motion feature; and downsampling an output of the neural network layer process.

For some embodiments of the second example method, obtaining the reference feature includes: obtaining the reconstructed reference frame; and downsampling the reconstructed reference frame to generate the reference feature.

For some embodiments of the second example method, the first motion compensated feature corresponds to a first level.

For some embodiments of the second example method, the second motion compensated feature corresponds to a second level, and the second level is different from the first level.

For some embodiments of the second example method, reconstructing the point cloud includes: generating a combined motion compensated feature with a first motion feature mix process with the first and the second motion compensated features as inputs; entropy decoding a main feature bitstream; generating a combined downsampled feature with a second motion feature mix process with the concatenated motion compensated feature and the entropy decoded main feature as inputs; and upsampling the combined downsampled feature to generate the reconstructed point cloud.

A third example method in accordance with some embodiments may include: obtaining a reference frame input point cloud; obtaining a current frame input point cloud; downsampling the reference frame; downsampling the current frame; performing a motion estimation with the downsampled reference frame and the downsampled current frame as inputs, wherein performing the motion estimation comprises performing a multi-resolution motion estimation process; quantizing an output of the motion estimation; and entropy encoding the quantized output.

Some embodiments of the third example method may further include arranging the entropy encoded quantized output in a motion feature bitstream.

For some embodiments of the third example method, performing the motion estimation includes: concatenating the downsampled reference frame and the downsampled current frame to generate a concatenated feature; feature enhancing the concatenated feature; and pruning the enhanced feature to generate the output of the motion estimation.

Some embodiments of the third example method may further include generating a main feature by a set of neural network layers with the current feature and the reference feature as inputs.

For some embodiments, an apparatus may be configured to perform any one of the example methods listed above.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining a first motion feature generated by a first set of neural network layers with a current feature and a reference feature as inputs;
obtaining a second motion feature generated by a second set of neural network layers with a downsampled current feature and a downsampled reference feature as inputs;
generating a third motion feature by upsampling the second motion feature;
generating a multi-resolution motion feature by a third set of neural network layers by merging the first and the third motion features; and
packing the multi-resolution motion feature into a bitstream.

2. The method of claim 1, further comprising:
obtaining a fourth motion feature generated by a fourth set of neural network layers with inputs of a two or more time downsampled current feature and a two or more time downsampled reference feature; and
generating a fifth motion feature by upsampling two or more times the fourth motion feature,
wherein generating the multi-resolution motion feature further comprises merging the fifth motion feature with the first and third motion features.

3. The method of claim 1, wherein obtaining the first motion feature comprises:
concatenating the current feature and the reference feature;
performing a feature enhancement process on the concatenated current and reference features; and
pruning the feature enhanced features to generate the first motion feature.

4. The method of claim 1, wherein obtaining the second motion feature comprises:
downsampling the current and reference features;
concatenating the downsampled current feature and the downsampled reference feature;
performing a feature enhancement process on the concatenated features; and
pruning the feature enhanced features to generate the second motion feature.

5. The method of claim 1, wherein generating the third motion feature comprises:
upsampling the second motion feature;
pruning the upsampled second motion feature to generate the third motion feature; and
passing at least one of the second or the third motion feature through a fifth set of neural network layers at least one of before or after upsampling the second motion feature.

6. The method of claim 1, wherein generating the multi-resolution motion feature comprises:
concatenating the first and third motion features; and
performing a feature enhancement neural network layer process on the concatenated motion features to generate the multi-resolution motion feature.

7. The method of claim 1, wherein packing the multi-resolution motion feature into the bitstream comprises:
quantizing the multi-resolution motion feature; and
entropy encoding the quantized multi-resolution motion feature; and
arranging the entropy encoded multi-resolution motion feature into the bitstream.

8. The method of claim 1, further comprising generating a main feature by a second set of neural network layers with the current feature and the reference feature as inputs.

9. The method of claim 7, wherein generating the main feature comprises:
downsampling the current feature;
downsampling the reference feature; and
performing a motion estimation using the downsampled current feature and the downsampled reference feature as inputs.

10. The method of claim 1, further comprising reconstructing a point cloud by a separate set of neural network layers with the bitstream as an input.

11. A method comprising:
decoding a multi-resolution motion feature from a bitstream;
generating a first motion feature by a first set of neural network layers with the multi-resolution motion feature as an input;
generating a second motion feature by a second set of neural network layers with the multi-resolution motion feature as an input;
obtaining a reference feature extracted from a reconstructed reference frame;
generating a first motion compensated feature by a third set of neural network layers with the first motion feature and the reference feature as inputs;
generating a second motion compensated feature by a fourth set of neural network layers with the second motion feature and the reference feature as inputs; and
reconstructing a point cloud by a separate set of neural network layers with the first and the second motion compensated features as inputs.

12. The method of claim 10, wherein generating the second motion feature comprises:
performing a neural network layer process on the second motion feature; and
downsampling an output of the neural network layer process.

13. The method of claim 10, wherein obtaining the reference feature comprises:
obtaining the reconstructed reference frame; and
downsampling the reconstructed reference frame to generate the reference feature.

14. The method of claim 10, wherein the first motion compensated feature corresponds to a first level.

15. The method of claim 10,
wherein the second motion compensated feature corresponds to a second level, and
wherein the second level is different from the first level.

16. The method of claim 10, wherein reconstructing the point cloud comprises:
generating a combined motion compensated feature with a first motion feature mix process with the first and the second motion compensated features as inputs;
entropy decoding a main feature bitstream;
generating a combined downsampled feature with a second motion feature mix process with the concatenated motion compensated feature and the entropy decoded main feature as inputs; and
upsampling the combined downsampled feature to generate the reconstructed point cloud.

17. A method comprising:
obtaining a reference frame input point cloud;
obtaining a current frame input point cloud;
downsampling the reference frame;
downsampling the current frame;
performing a motion estimation with the downsampled reference frame and the downsampled current frame as inputs,
wherein performing the motion estimation comprises performing a multi-resolution motion estimation process;
quantizing an output of the motion estimation; and
entropy encoding the quantized output.

18. The method of claim 17, further comprising arranging the entropy encoded quantized output in a motion feature bitstream.

19. The method of claim 17, wherein performing the motion estimation comprises:
concatenating the downsampled reference frame and the downsampled current frame to generate a concatenated feature;
feature enhancing the concatenated feature; and
pruning the enhanced feature to generate the output of the motion estimation.

20. The method of claim 17, further comprising generating a main feature by a set of neural network layers with the current feature and the reference feature as inputs.
